(19) United States
(12) Patent Application Publication
(10) Pub. No.: US 2026/0119904 A1
(43) Pub. Date: Apr. 30, 2026

(54) PARAMETER SELECTION METHOD AND PARAMETER SELECTION SYSTEM FOR REAL-TIME NEURAL NETWORK COMPUTING ARCHITECTURE

(71) Applicant: REALTEK SEMICONDUCTOR CORP., HSINCHU (TW)

(72) Inventor: Chia-Jung Wu, HSINCHU (TW)

(21) Appl. No.: 19/174,120

(22) Filed: Apr. 9, 2025

(30) Foreign Application Priority Data
Oct. 24, 2024 (TW) 113140454

(51) Int. Cl. G06N 3/0985; G06N 3/0464

(52) U.S. Cl. CPC G06N 3/0985; G06N 3/0464

(57) ABSTRACT

A parameter selection method and a parameter selection system for a real-time neural network computing architecture are provided. The parameter selection method includes: obtaining a fetching strategy combination for a target real-time neural network computing architecture, and the access strategy combination includes a plurality of fetching strategies. Each of the fetching strategies defines a plurality of fetching parameters used by a data fetching circuit when accessing a memory. The parameter selection method further includes configuring multiple ones of the data fetching circuit to access the memory according to each fetching strategy, and configuring a plurality of computing tiles to execute the convolution operation process for each fetching strategy, so as to obtain an optimized fetching strategy used to execute the convolution operation process.

### CROSS-REFERENCE TO RELATED PATENT APPLICATION

This application claims the benefit of priority to Taiwan Patent Application No. 113140454, filed on Oct. 24, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method and a system, and more particularly to a parameter selection method and a parameter selection system for a real-time neural network computing architecture.

### BACKGROUND OF THE DISCLOSURE

In recent years, the rapid development of artificial intelligence has led to the widespread application of neural network models in various aspects of life and technology. Depending on types of application, neural network models are divided into non-real-time and real-time computing architectures. In the non-real-time computing architecture, all data needs to be loaded into a memory before computing. In real-time neural network architectures, for example, when applied to noise reduction functions, the neural network must perform real-time computations simultaneously as data is input.

However, neural network architectures have various model parameters, and different combinations of these parameters can lead to a wide range of variations in the neural network architecture. Additionally, the settings used in different computing circuits can also affect the performance of the neural network architectures. However, it is not possible to determine in advance how to adjust these parameters to achieve the best performance.

### SUMMARY OF THE DISCLOSURE

In response to the above-referenced technical inadequacies, the present disclosure provides a parameter selection method and a parameter selection system for real-time neural network computing architectures capable of gradually identifying optimal parameter combinations and improving computational efficiency during data processing.

In order to solve the above-mentioned problems, one of the technical aspects adopted by the present disclosure is to provide a parameter selection method for a real-time neural network computing architecture, and the parameter selection method includes configuring a computing device of a parameter selection system to perform following processes: obtaining an fetching strategy combination for a target real-time neural network computing architecture, wherein the fetching strategy combination includes a plurality of fetching strategies, and the target real-time neural network computing architecture includes a memory, a plurality of data fetching circuits and a plurality of computing tiles. The plurality of data fetching circuits are connected to the memory through a bus. Each of the fetching strategies defines a plurality of fetching parameters used by the data fetching circuits when accessing the memory. The plurality of computing tiles respectively connected to the data fetching circuits and each including a plurality of processing elements. The parameter selection method further includes: configuring the plurality of data fetching circuits to access the memory according to each of the plurality of fetching strategies, and configuring the plurality of computing tiles to execute a convolution operation process for each of the plurality of fetching strategies, so as to obtain an optimized fetching strategy used to execute the convolution operation process.

In order to solve the above-mentioned problems, another one of the technical aspects adopted by the present disclosure is to provide a parameter selection system for a real-time neural network computing architecture, the parameter selection system includes a computing device and a target real-time neural network computing architecture. The target real-time neural network computing architecture includes a memory, a plurality of data fetching circuits and a plurality of computing tiles. The plurality of data fetching circuits are connected to the memory through a bus. The plurality of computing tiles respectively connected to the data fetching circuits and each including a plurality of processing elements. The computing device is configured to perform following processes: obtaining an fetching strategy combination for the target real-time neural network computing architecture, in which the fetching strategy combination includes a plurality of fetching strategies; and configuring the plurality of data fetching circuits to access the memory according to each of the plurality of fetching strategies, and configuring the plurality of computing tiles to execute a convolution operation process for each of the plurality of fetching strategies, so as to obtain an optimized fetching strategy used to execute the convolution operation process.

Therefore, in the parameter selection method and the parameter selection system for the real-time neural network computing architecture, optimal parameter combinations can be gradually identified during data processing, and a progressive adjustment mechanism allows for immediate optimization, thereby effectively improving computational efficiency.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of a parameter selection system for a real-time neural network computing architecture according to one embodiment of the present disclosure;

FIG. 2 is a functional block diagram of the target real-time neural network computing architecture according to one embodiment of the present disclosure;

FIG. 3 is a flowchart of a convolution operation process according to one embodiment of the present disclosure;

FIG. 4 is a simplified structural diagram of a convolutional neural network model;

FIG. 5 is a flowchart of a parameter selection method for a real-time neural network computing architecture according to one embodiment of the present disclosure; and

FIG. 6 is another flowchart of the parameter selection method for the real-time neural network computing architecture according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

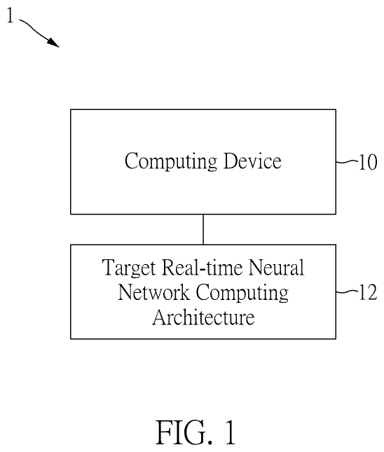

FIG. 1 is a functional block diagram of a parameter selection system for a real-time neural network computing architecture according to one embodiment of the present disclosure. Referring to FIG. 1, one embodiment of the present disclosure provides a parameter selection system 1 for a real-time neural network computing architecture, and the parameter selection system 1 includes a computing device 10 and a target real-time neural network computing architecture 12. The computing device 10 can be, for example, a general-purpose computer system, and the target real-time neural network computing architecture 12 can be included in the computing device 10 or electrically connected to the computing device 10, and the present disclosure does not limit a relationship therebetween. Specifically, the computing device 10 and the target real-time neural network computing architecture 12 can include architectures implemented by one or more of hardware, software, and firmware. The present disclosure does not limit specific implementations of the computing device 10 and the target real-time neural network computing architecture 12.

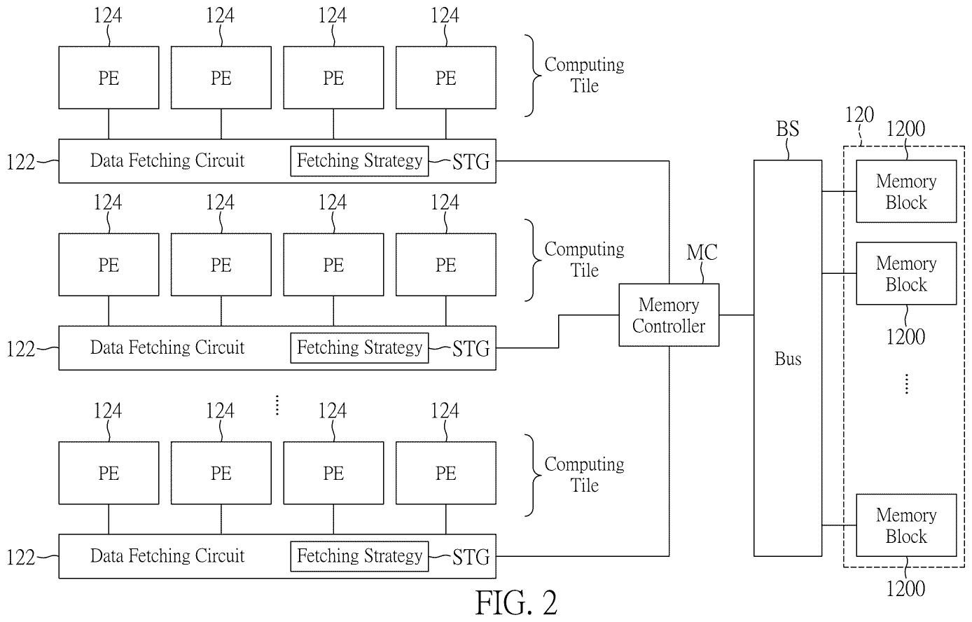

FIG. 2 is a functional block diagram of the target real-time neural network computing architecture according to one embodiment of the present disclosure. Referring to FIG. 2, the target real-time neural network computing architecture 12 includes a memory 120, a plurality of data fetching circuits 122, and a plurality of processing elements 124.

The data fetching circuit 122 can be connected to the memory 120 through a memory controller MC and a bus BS. The memory 120 can include a plurality of memory blocks 1200, and each of the memory blocks 1200 can be, for example, a memory bank. Each of the data fetching circuits 122 can be configured to obtain to-be-processed data from the memory 120 according to the fetching strategy STG. For example, the fetching strategy STG can define a plurality of fetching parameters used by the data fetching circuits when accessing the memory, including the order in which the memory blocks 1200 are read. For example, if there are 16 memory blocks 1200, the fetching strategy STG can be a plurality of memory addresses arranged in sequence, such as 0x00, 0x10, 0x20, . . . , etc. In addition, in some embodiments, the fetching strategy STG also includes a configuration in which each of the data fetching circuits 122 allocates and reads the memory 120 through the bus BS. For example, in one read time interval, each data fetching circuit 122 reads a predetermined quantity of the memory blocks 1200.

On the other hand, the processing element (PE) 124 can be implemented by using one or more processing circuits (e.g., processor(s)), and can be a fundamental computation unit that is used to execute a convolution operation process according to a convolution neural network model. Each of the data fetching circuit 122 can be connected to a computing tile. Each computing tile can include one or more of the PEs 124. As shown in FIG. 2, there can be four PEs 124, but the present disclosure is not limited thereto. The to-be-processed data obtained from the memory 120 can be input into the corresponding PE 124 to execute the convolution operation process.

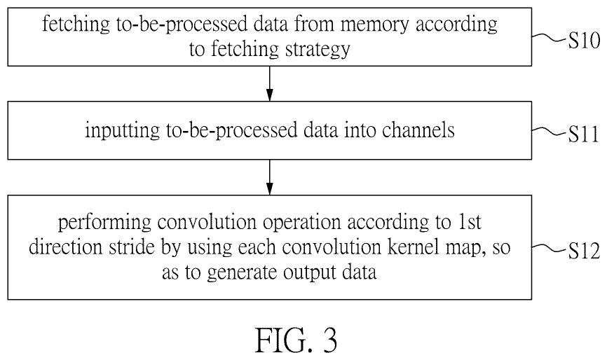

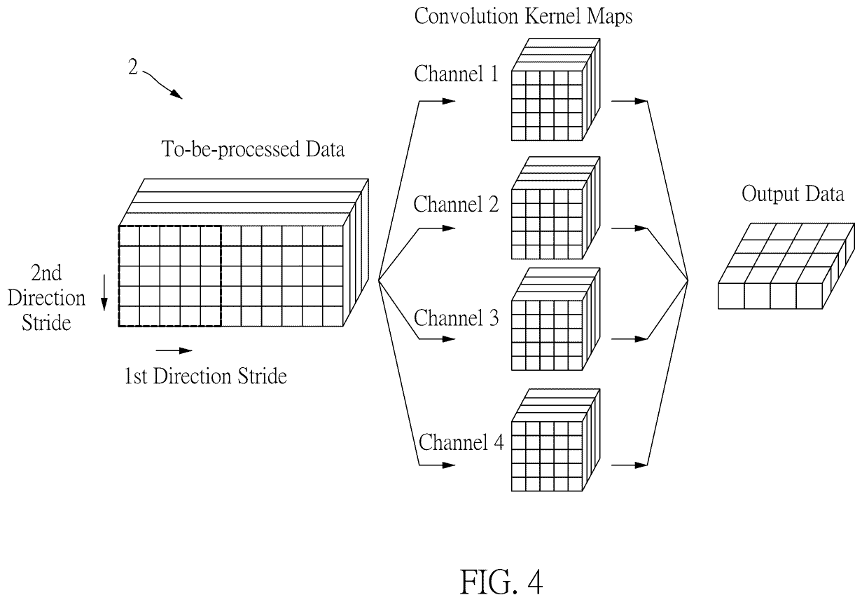

FIG. 3 is a flowchart of a convolution operation process according to one embodiment of the present disclosure, and FIG. 4 is a simplified structural diagram of a convolutional neural network model. Referring to FIG. 3 and FIG. 4, the convolution operation process can include the following steps:
Step S10: fetching the to-be-processed data from the memory according to the fetching strategy. In step S10, as long as a part of the to-be-processed data is input, the computing proceeds.
Step S11: inputting the to-be-processed data into the plurality of channels. In step S11, each channel can process a convolution kernel map.
Step S12: performing a convolution operation according to a first direction stride by using each of the convolution kernel maps, so as to generate a plurality of records of output data.

Taking FIG. 4 as an example, the convolution neural network model 2 of FIG. 4 has four channels, and an amount of to-be-processed data can be, for example, a matrix with a width of 11 and a height of 5, and the four channels represent four sets of convolution kernel maps. Each convolution kernel map has a kernel size. Taking FIG. 4 as an example, the kernel size has a width of 5, a height of 5, and a channel size of 4.

In addition, the first direction stride represents an amount of data to be moved in the first direction (e.g., X direction) after the convolution. The first direction stride of FIG. 4 is 2. Therefore, when the to-be-processed data is convolved through the first channel and the first set of convolution kernel map, four output results after the convolution are obtained as the output data. Similarly, the second to fourth sets of the convolution kernel maps can be used to process the data in the same manner, resulting in the output of each set after convolution operations.

Additionally, when new data is input and it is necessary to move to the next layer (e.g., a second direction) for convolution operations, each convolution kernel map is used to perform convolution on the new input data based on a second direction stride. The computation directions for the first direction stride and the second direction stride are different. For example, if the first direction stride represents the number of steps the convolution kernel map moves in the X direction, the second direction stride represents the number of steps the convolution kernel map moves in the Y direction.

Referring to FIG. 2 again, when the target real-time neural network computing architecture 12 of FIG. 1 is used to perform the convolution operation process of FIG. 3, the four computing tiles of FIG. 2 each contain four PEs, and the four output results of each tile can be calculated by four PE circuits 124, respectively. Similarly, when the second set of convolution kernel map of the second channel is used to perform convolution operations on the to-be-processed data, the convolution operation can be performed in the second computing tile, and the four PEs 124 are used to calculate the corresponding four output results.

However, it can be seen from the above that when fetching the memory 120, the to-be-processed data and data of the convolution kernel map can be obtained. The fetching strategy for the memory 120, such as the order of reading the memory blocks and the configuration according to which the memory is allocated and read through the bus, will affect computational efficiency. Therefore, it is necessary to identify the optimal parameter combination to ensure that the target real-time neural network computing architecture 12 operates at peak performance. It is worth mentioning that the width and height of the to-be-processed data, the first direction stride, the second direction stride, the number of input channels, the number of output channels, and the width and height of the convolution kernel can be set by a register. In some embodiments, a dedicated memory can be accessed to obtain the above data for use by the register, but the present disclosure is not limited thereto.

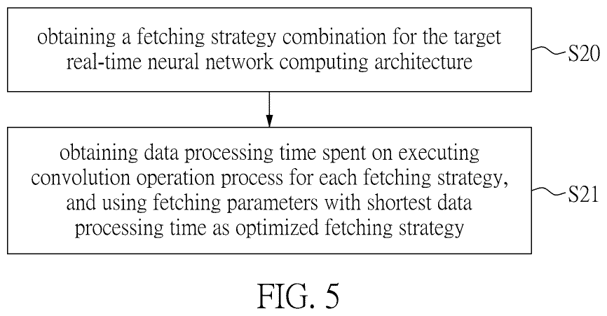

Referring to FIG. 5, FIG. 5 is a flowchart of a parameter selection method for a real-time neural network computing architecture according to one embodiment of the present disclosure. In order to find the most suitable parameter combination, the present disclosure further provides a parameter selection method for the real-time neural network computing architecture, and the parameter selection method includes configuring the computing device 10 to perform the following steps:
Step S20: obtaining a fetching strategy combination for the target real-time neural network computing architecture. In this step, the fetching strategy combination includes a fetching strategy STG for each of the data fetching circuits 122, and each fetching strategy STG defines a plurality of fetching parameters used by the data fetching circuits when accessing the memory.
Step S21: obtaining the data processing time spent on executing the convolution operation process for each of the plurality of fetching strategies, and using the fetching parameters with the shortest data processing time as the optimized fetching strategy.

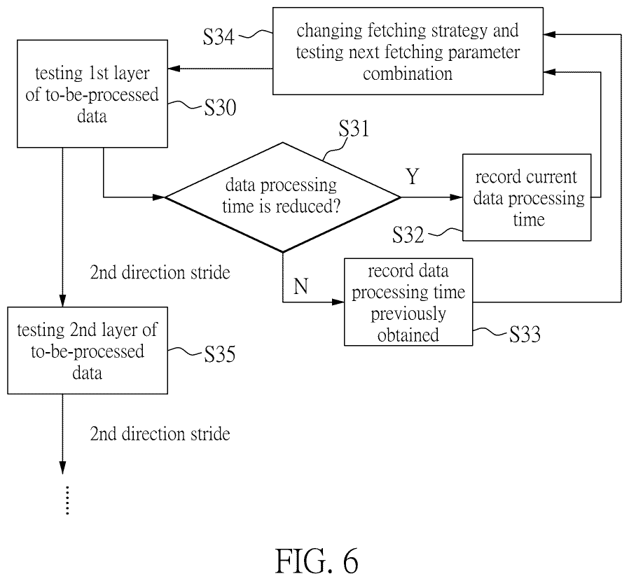

Referring to FIG. 6, FIG. 6 is another flowchart of the parameter selection method for the real-time neural network computing architecture according to one embodiment of the present disclosure. Taking FIG. 6 as an example, for the to-be-processed data for testing, the parameter selection method further includes:
Step S30: testing a first layer of to-be-processed data according to a fetching parameter combination of one of the fetching strategies to obtain a data processing time.
Step S31: determining whether the data processing time is reduced; If affirmative, executing step S32 to record the current data processing time; If negative, executing step S33 to record a data processing time previously obtained.

After steps S31 and S32, the parameter selection method proceeds to step S34: changing the fetching strategy and testing a next fetching parameter combination.

After testing the first layer of to-be-processed data, proceed with the second direction stride and the parameter selection method proceeds to step S35, where the data processing time for the second layer of the to-be-processed data will be tested. This process continues until the data processing time for the last layer of the to-be-processed data is tested. Then, the second direction stride is applied and the parameter selection method returns to step S30 to test the first layer of to-be-processed data with the next fetching strategy parameter combination obtained from step S34. Steps S31 to S35 are executed until all fetching parameter combinations for all layers are tested. It should be noted that each layer of to-be-processed data will go through the cycle of steps S31 to S35 (including determining whether the data processing time is reduced, recording the data processing time and testing the fetching parameter combination).

### Beneficial Effects of the Embodiments

Therefore, in the parameter selection method and the parameter selection system for the real-time neural network computing architecture, optimal parameter combinations can be gradually identified during data processing, and a progressive adjustment mechanism allows for immediate optimization, thereby effectively improving computational efficiency.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A parameter selection method for a real-time neural network computing architecture, the parameter selection method comprising: configuring a computing device of a parameter selection system to perform following processes:
obtaining a fetching strategy combination for a target real-time neural network computing architecture, wherein the fetching strategy combination includes a plurality of fetching strategies, and the target real-time neural network computing architecture includes:
a memory;
a plurality of data fetching circuits connected to the memory through a bus, wherein each of the fetching strategies defines a plurality of fetching parameters used by the data fetching circuits when accessing the memory; and
a plurality of computing tiles respectively connected to the data fetching circuits and each including a plurality of processing elements;
configuring the plurality of data fetching circuits to access the memory according to each of the plurality of fetching strategies, and configuring the plurality of computing tiles to execute a convolution operation process for each of the plurality of fetching strategies, so as to obtain an optimized fetching strategy used to execute the convolution operation process.

2. The parameter selection method according to claim 1, wherein the memory includes a plurality of memory blocks, and the plurality of fetching parameters of each of the plurality of fetching strategies respectively define an order in which the plurality of data fetching circuits read the plurality of memory blocks and a configuration according to which the plurality of memory blocks are allocated and read through the bus.

3. The parameter selection method according to claim 2, wherein the convolution operation process includes:
inputting to-be-processed data obtained by reading the memory according to the corresponding fetching strategy into a plurality of channels of a convolutional neural network model, wherein each of the channels includes a convolution kernel map; and
performing a convolution operation according to a first direction stride and a second direction stride by using each of the convolution kernel maps, so as to generate a plurality of records of output data, and recording data processing time corresponding to the convolution operation.

4. The parameter selection method according to claim 3, wherein each of the plurality of convolution kernel maps has a kernel size, and an operation direction of the first direction stride is different from an operation direction of the second direction stride.

5. The parameter selection method according to claim 4, wherein the processes of obtaining the optimized fetching strategy used to execute the convolution operation process includes obtaining the data processing time spent on executing the convolution operation process for each of the plurality of fetching strategies, and using the fetching parameters with the shortest data processing time as the optimized fetching strategy.

6. A parameter selection system for a real-time neural network computing architecture, the parameter selection system comprising:
a computing device; and
a target real-time neural network computing architecture, including:
a memory;
a plurality of data fetching circuits connected to the memory through a bus; and
a plurality of computing tiles respectively connected to the data fetching circuits and each including a plurality of processing elements;
wherein the computing device is configured to perform following processes:
obtaining a fetching strategy combination for the target real-time neural network computing architecture, wherein the fetching strategy combination includes a plurality of fetching strategies; and
configuring the plurality of data fetching circuits to access the memory according to each of the plurality of fetching strategies, and configuring the plurality of computing tiles to execute a convolution operation process for each of the plurality of fetching strategies, so as to obtain an optimized fetching strategy used to execute the convolution operation process.

7. The parameter selection system according to claim 6, wherein the memory includes a plurality of memory blocks, and the plurality of fetching parameters of each of the plurality of fetching strategies respectively define an order in which the plurality of data fetching circuits read the plurality of memory blocks and a configuration according to which the plurality of memory blocks are allocated and read through the bus.

8. The parameter selection system according to claim 7, wherein the convolution operation process includes:
inputting to-be-processed data obtained by reading the memory according to the corresponding fetching strategy into a plurality of channels of a convolutional neural network model, wherein each of the channels includes a convolution kernel map; and
performing a convolution operation according to a first direction stride and a second direction stride by using each of the convolution kernel maps, so as to generate a plurality of records of output data, and recording data processing time corresponding to the convolution operation.

9. The parameter selection system according to claim 8, wherein each of the plurality of convolution kernel maps has a kernel size, and an operation direction of the first direction stride is different from an operation direction of the second direction stride.

10. The parameter selection system according to claim 9, wherein the processes of obtaining the optimized fetching strategy used to execute the convolution operation process includes obtaining the data processing time spent on executing the convolution operation process for each of the plurality of fetching strategies, and using the fetching parameters with the shortest data processing time as the optimized fetching strategy.
